(19) United States
(12) Patent Application Publication
(10) Pub. No.: US 2024/0399400 A1
(43) Pub. Date: Dec. 5, 2024

(54) CONNECTOR UNIT FOR A SPRAY GUN, SPRAY GUN AND METHOD FOR OPERATING A SPRAY GUN

(71) Applicant: WiWa Welhelm Wagner GmbH & Co. KG, Lahnau (DE)

(72) Inventor: Marco Schargitz, Biebertal (DE)

(21) Appl. No.: 18/731,264

(22) Filed: Jun. 1, 2024

(30) Foreign Application Priority Data
Jun. 1, 2023 (DE) 10 2023 114 398.0

(51) Int. Cl. B05B 7/24; B05B 7/12

(52) U.S. Cl. CPC B05B 7/2416; B05B 7/129

(57) ABSTRACT

A connector unit (23) for a spray gun (10) for spraying a flowable material using compressed air includes a first connector (28) for the connection of an air line (29) and a second connector (30) for the connection of a material line (31), the connector unit being configured as a swivel joint (25) in such a manner that the first connector and the second connector are rotatable around a shared rotation axis (32) relative to the spray gun.

This application claims priority to German Patent Application No. 10 2023 114 398.0 filed on Jun. 1, 2023, the disclosure of which is incorporated herein by reference.

### TECHNICAL FIELD

The invention relates to a connector unit for a spray gun for spraying a flowable material using compressed air, to a spray gun for spraying a flowable material using compressed air, to a method for operating a spray gun configured for spraying a flowable material using compressed air and to a use of a connector unit for a spray gun configured for spraying a flowable material using compressed air.

### BACKGROUND

A spray gun of the kind mentioned above is well-known from the state of the art and is commonly used for painting; a flowable material, for example a paint material or a paint, being dispensable onto an object to be painted by means of the spray gun using compressed air. Typically, a handle of the spray gun has a first connector at the end, to which an air line coming from a compressed-air source is connected, and a shaft of the spray gun has a second connector in the area of a nozzle unit of the spray gun, to which a material line coming from a material source is connected. Thus, the spray gun has two connection points, which limits the freedom of movement of the operator when operating the spray gun.

### SUMMARY

Therefore, the object of the present invention is to propose a connector unit for a spray gun, a spray gun, a method for operating a spray gun and a use of a connector unit for a spray gun which allow the spray gun to be operated in a simpler manner.

The connector unit according to the invention for a spray gun for spraying a flowable material using compressed air has a first connector for the connection of an air line and a second connector for the connection of a material line, the connector unit being configured as a swivel joint in such a manner that the first connector and the second connector are rotatable around a shared rotation axis relative to the spray gun.

Thus, the air line, which can be connected to a compressed-air source with one end, and the material line, which can be connected to a material line with one end, can be connected to the spray gun at essentially a single connection point by means of the connector unit. Furthermore, the connector unit is configured as a swivel joint in such a manner that the first connector and the second connector, which is formed separate from the first connector, are rotatable around a shared rotation axis relative to the spray gun when the connector unit is arranged on the spray gun.

During operation of the spray gun, the air line connected to the spray gun via the connector unit or the first connector can be rotated around the shared rotation axis together with the material line also connected to the spray gun via the connector unit or the second connector, in particular when the spray gun is rotated by an operator, which increases the freedom of movement of the operator and thus simplifies operation of the spray gun.

Advantageously, the connector unit can be configured for being arranged on a handle of the spray gun. Preferably, the connector unit can be fastened to the end of the handle. The rotation axis can run parallel to a longitudinal axis of the handle.

Advantageously, the connector unit can comprise a fixed part fixed relative to the spray gun when the connector unit is arranged on the spray gun, and a swivel part rotatably connected to the fixed part; the swivel part can have the first connector and the second connector.

Advantageously, the compressed air and the material are separately guidable from the swivel part to the spray gun via the fixed part, for which separately formed air passages and material passages can be provided in the swivel part and the fixed part.

Furthermore, the swivel part can comprise a first connector element, which can comprise the first connector, and a second connector element, which can comprise the second connector, said second connector element bring rigidly connected to the first connector element. The first connector element can form a central portion forming a passageway and a side portion forming the first connector. Furthermore, in addition to the second connector, the second connector element can form a material channel disposed in an axial direction, meaning parallel to the rotation axis, downstream of the second connector.

Furthermore, the fixed part can comprise a socket element rigidly connectable to the spray gun and an axis element rigidly connected to the socket element, the swivel part being rotatably mounted on said axis element. The axis element can be inserted in the passageway. With a first end of the axis element accommodated in the passageway, the axis element can extend into the material channel which is formed from the second connector element engaging in a broadened first end of the passageway and which is disposed behind the second connector in the axial direction, wherein the axis element can abut against the second connector element via a seal of the connector unit so as to be impermeable by material. Radially on the outside in a contact area of the seal, the first connector element can form an overflow through which the material can overflow to the outside in the event of a defect of the seal. A gap, a smear layer or a bearing, in particular an axial plain bearing, can be provided between a flange of the axis element and the second connector element. With a second end of the axis element protruding over the passageway in the axial direction, the axis element can extend into a material channel which is formed by the socket element engaging into a broadened second end of the passageway and which can kink perpendicular to the axial direction in a further course of the material channel, essentially into a dispensing direction of the material from the spray gun, and which can lead to a material outlet of the socket element, said material outlet being connectable to a material inlet of the spray gun disposed on a shaft of the spray gun via a material line.

The axis element can have a material channel in this case. Thus, the material supplied by means of the material line can enter a mixing chamber of the spray gun from a material source, to which the material line can be connected, by passing through the material channel of the second connector element, subsequently passing through the material channel of the axis element, further subsequently passing through the material channel of the socket element and further subsequently passing through the material line, said mixing chamber being disposed in the shaft.

Advantageously, the connector unit can comprise a bearing arrangement having at least one bearing via which the swivel part can be rotatably connected to the fixed part. The bearing can be an axial bearing or a radial bearing. Furthermore, the bearing can be a rolling bearing or a plain bearing. The bearing arrangement can comprise in particular two or three bearings. The bearing, which can be provided between the flange and the second connector element, can be part of the bearing arrangement.

In an advantageous embodiment, the bearing arrangement can comprise at least one axial bearing, preferably an axial rolling bearing. Furthermore, the bearing arrangement can comprise a radial bearing, preferably a radial plain bearing. The plain bearing can be disposed in the axial direction adjacent to the axial rolling bearing. By means of the axial bearing, the swivel part can be particularly easily fastened to the fixed part along the axial direction and still be rotatably connected to the fixed part. For example, the axial bearing can be fastened to the flange and to a ledge formed by an inner wall of the central portion in the passageway, said ledge being provided in the axial direction downstream of the flange, in order to fasten the swivel part, which rests on the axial bearing, along the axial direction relative to the fixed part and, preferably together with the plain bearing, to allow the rotation of the swivel part around the rotation axis relative to the fixed part. The axial bearing can preferably be a rolling bearing, in particular a ball bearing. The bearing arrangement can comprise another axial bearing, in particular an axial plain bearing, which can be disposed opposite the axial direction adjacent to the axial bearing, in particular between the flange and the second connecting element.

To guide the compressed air from the swivel part to the fixed part irrespective of a rotation angle formed between the fixed part and the swivel part, the fixed part or the socket part can have or form an air channel, wherein the swivel part or the first connector element or the central portion can have or form a ring channel for the compressed air which can open into the air channel in such a manner that the compressed air can be guidable from the ring channel into the air channel irrespective of the rotation angle formed between the fixed part and the swivel part. The ring channel can be limited by the fixed part or the socket element in the axial direction.

Advantageously, the connector unit or the socket part can be disposed such on the spray gun that the air channel of the fixed part or of the socket part can lead to an air inlet of the handle or open into an air channel of the handle disposed downstream of the air inlet in the axial direction.

Advantageously, the swivel part or the first connector element or the side portion can have or form an air channel extending preferably at an angle to the rotation axis from the first connector to the ring channel.

Thus, the compressed air introduced by means of the air line can enter the mixing chamber from a compressed-air source, to which the line can be connected, by passing through the air channel of the first connector element or of the side portion, subsequently passing through the ring channel of the first connector element or of the central portion, further subsequently passing through the air channel of the socket element and further subsequently passing through the air channel of the handle.

The fixed part or the socket part can have or form the material outlet which can be connectable to a material inlet of the spray gun via the material line, said material inlet being disposed on the shaft of the spray gun. The connector unit or the spray gun can comprise the material line. Advantageously, the material can be guidable parallel to the rotation axis from the swivel part into the fixed part by means of the connector unit.

The connector unit can comprise a fastening element for fastening the connector unit or the socket element to the spray gun. The fastening element can be configured such that the connector unit can be detachably fastened to the spray gun, in particular by means of screws. For example, the fastening element can be a cap nut having an internal thread which can be screwed onto an external thread of the handle.

The spray gun according to the invention for spraying a material using compressed air comprises a connector unit according to the invention.

Advantageously, the spray gun can comprise a handle, a shaft, a mixing chamber, a nozzle unit, a valve unit and a trigger. By an operator of the spray gun actuating the trigger, the material can be supplied to the mixing chamber, where it can interact with the compressed air flowing into the mixing chamber by actuating the trigger, so that it can be dispensed as a spray afterwards by means of a nozzle of the nozzle unit. The spray gun can comprise a housing which can have or form the handle and the shaft. Preferably at its end, the handle can have or form an air inlet and an air channel located downstream of the air inlet in the axial direction so that the compressed air can enter the spray gun via the air inlet and the mixing chamber via the air channel. Furthermore, the spray gun can have or form a material inlet via which the material can enter the mixing chamber, said material inlet being disposed on the shaft. The housing can house the mixing chamber, the nozzle unit and the valve unit. Advantageously, the spray gun can be used for painting. Thus, the dispensed material can in particular be a paint material or a paint or a varnish.

In the method according to the invention for operating a spray gun configured for spraying a flowable material using compressed air, an air line is connected to a first connector of a connector unit of the spray gun and a material line is connected to a second connector of the connector unit, the first connector and the second connector being rotated relative to the spray gun around a shared rotation axis, in particular when rotating the spray gun, by means of the connector unit configured as a swivel joint.

For further details on the advantageous effects of the method according to the invention, reference is made to the description of advantages of the connector unit according to the invention.

Further advantageous embodiments of the method according to the invention are apparent from the description of features of the dependent claims referring back to device claim 1.

According to the invention, a connector unit for a spray gun configured for spraying a flowable material using compressed air is used, the connector unit having a first connector for the connection of an air line and a second connector for the connection of a material line, the connector unit being configured as a swivel joint in such a manner that the first connector and the second connector are rotatable around a shared rotation axis relative to the spray gun.

For further details on the advantageous effects of the use according to the invention, reference is made to the description of advantages of the connector unit according to the invention.

Further advantageous embodiments of the use according to the invention are apparent from the description of features of the dependent claims.

### BRIEF DESCRIPTION OF THE DRAWINGS

Hereinafter, a preferred embodiment of the invention will be described in more detail with reference to the attached drawing.

FIG. 1 shows a sectional view of a spray gun;

FIG. 2 shows a detailed view of FIG. 1 in the area of a connector unit of the spray gun.

### DETAILED DESCRIPTION

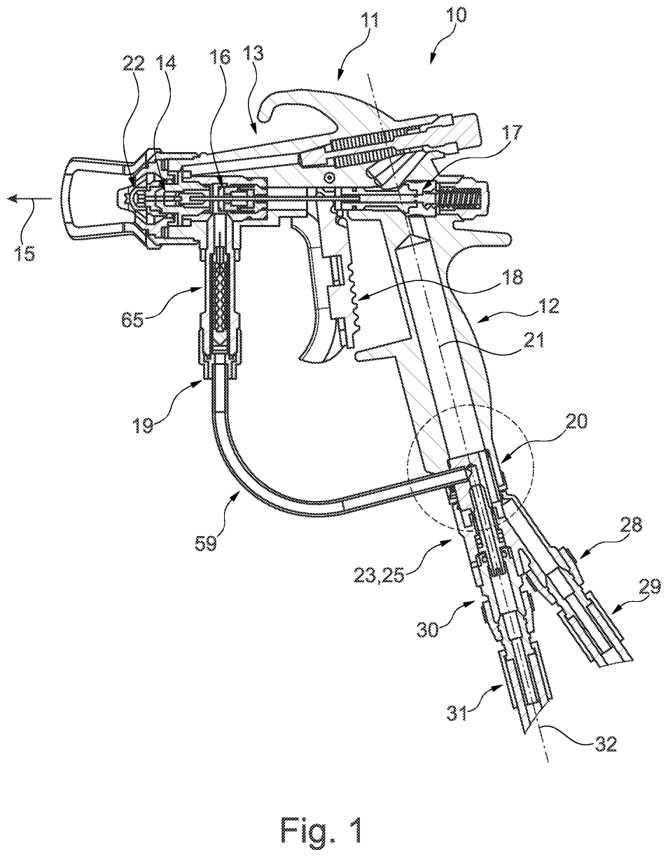

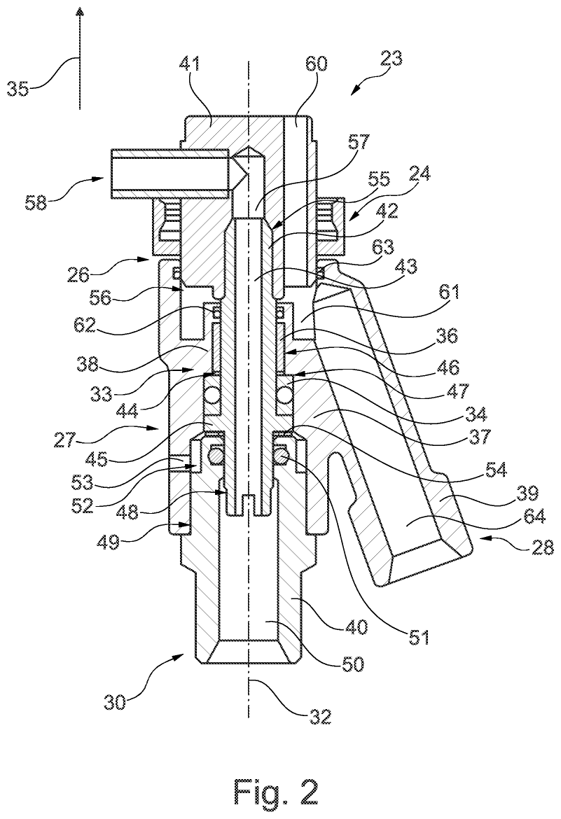

A combined view of FIGS. 1 and 2 shows a spray gun 10 for dispensing a flowable material using compressed air, said spray gun 10 comprising a housing 11, which forms a handle 12 and a shaft 13. Furthermore, spray gun 10 comprises a nozzle unit 14 which is disposed at the end in shaft 13, a mixing chamber 16 which is disposed in a dispensing direction 15 of the material upstream of nozzle unit 14 and which is disposed in shaft 13, and a valve unit 17 which disposed in shaft 13 and which is coupled to a trigger 18 laterally disposed on shaft 13. The material can enter spray gun 10 and thus mixing chamber 16 via a material inlet 19 of spray gun 10 by passing through a filter unit 65, said material inlet 19 being laterally disposed on shaft 13. The compressed air can enter spray gun 10 via an air inlet 20 formed by handle 12 at the end of spray gun 10, an air channel 21, which is formed by handle 12 and via which the compressed air can enter mixing chamber 16, being located behind air inlet 20. By an operator of spray gun 10 actuating trigger 18, the material can be supplied to mixing chamber 16, where it can interact with the compressed air flowing into mixing chamber 16 by actuating trigger 18, so that it can be dispensed as a spray afterwards by means of a nozzle 22 of nozzle unit 14.

Furthermore, spray gun 10 comprises a connector unit 23 which is fastened to the end of handle 12 by means of a fastening element 24 of connector unit 23. Connector unit 23, which is configured as a swivel joint 25, comprises a fixed part 26 fixed relative to spray gun 10 and a swivel part 27 rotatably connected to fixed part 26, swivel part 27 having a first connector 28, to which an air line 29 is connected, and having a second connector 30, to which a material line 31 is connected. First connector 28 and second connector 30 are rotatable around a shared rotation axis 32 relative to spray gun 10 so that the freedom of movement of the operator is increased. To this end, connector unit 23 comprises a bearing arrangement 33 having an axial rolling bearing 34, having a radial plain bearing 36, which is disposed in axial direction 35 parallel to rotation axis 32 adjacent to axial rolling bearing 34, and having an axial plain bearing 54, which is disposed opposite axial direction 35 adjacent to axial rolling bearing 34, which rotatably connect swivel part 27 to fixed part 26.

More specifically, swivel part 27 comprises a first connector element 37, which forms a central portion 38 and a side portion 39, side portion 39 forming first connector 28, and said swivel part 27 comprises a second connector element 40, which is rigidly connected to first connector element 37 and which forms second connector 30. Furthermore, fixed part 26 comprises a socket element 41 rigidly connected to handle 12 by means of fastening element 24 and an axis element 42 rigidly connected to socket element 41, swivel part 27 being rotatably mounted on said axis element 42 via bearing arrangement 33.

Axis element 42, which forms a material channel 43, is inserted in a passageway 44 formed by central portion 38; axial rolling bearing 34, which is fastened to a flange 45 of axis element 42 and to a ledge 47, fastening swivel part 27, which rests on axial rolling bearing 34, along axial direction 35 relative to fixed part 26 and, together with radial plain bearing 36, allowing the rotation of swivel part 27 around rotation axis 32 relative to fixed part 26, said ledge 47 being provided in axial direction 35 downstream of flange 45 and being formed by an inner wall 46 of central portion 38 in passageway 44. With a first end 48 of axis element 42 accommodated in passageway 44, axis element 42 extends into material channel 50 which is formed from second connector element 40 engaging in a broadened first end 49 of passageway 44 and which is disposed downstream of second connector 30 in axial direction 35, wherein axis element 42 abuts against second connector element 40 via a seal 51 of connector unit 23 so as to be impermeable my material. Radially on the outside in a contact area 52 of seal 51, first connector element 37 forms an overflow 53 through which the material can overflow to the outside in the event of a defect of seal 51. Axial plain bearing 54 is provided between flange 45 and second connector element 40. With a second end 55 of axis element 42 protruding over passageway 44 in axial direction 35, axis element 42 extends into a material channel 57 which is formed by the socket element engaging into a broadened second end 56 of passageway 44 and which kinks perpendicular to axial direction 35 in a further course of material channel 57, essentially into dispensing direction 15, and which leads to a material outlet 58 of socket element 41, said material outlet 58 being connected to material inlet 19 via a material line 59 of connector unit 23. Thus, the material supplied by means of material line 31 can enter mixing chamber 16 from a material source (not shown), to which material line 31 can be connected, by passing through material channel 50 of second connector element 40, subsequently passing through material channel 43 of axis element 42, further subsequently passing through material channel 57 of socket element 41 and further subsequently passing through material line 59.

Furthermore, socket element 41 forms an air channel 60, central portion 38 or broadened second end 56 forming a ring channel 61 for the compressed air which is limited by socket element 41 in axial direction 35 and which opens into air channel 60 in such a manner that the compressed air can be guided from ring channel 61 into air channel 60 irrespective of a rotation angle formed between fixed part 26 or socket element 41 and swivel part 27 or first connector element 37. First connector element 37 abuts against axis element 42 via a seal 62 and against socket element 41 via a seal 63 in an air-tight manner. Furthermore, socket element 41 is disposed on handle 12 or air inlet 20 in such a manner that air channel 60 opens into air channel 21. Furthermore, side portion 39 forms an air channel 64 extending from first connector 28 to ring channel 61 at an angle to rotation axis 32. Thus, the compressed air introduced by means of air line 29 can enter mixing chamber 16 from a compressed-air source (not shown), to which air line 29 can be connected, by passing through air channel 64 of first connector element 37, subsequently passing through ring channel 61 of first connector element 37, further subsequently passing through air channel 60 of socket element 41 and further subsequently passing through air channel 21 of handle 12.

1. A connector unit (23) for a spray gun (10) for spraying a flowable material using compressed air, the connector unit comprising a first connector (28) for the connection of an air line (29) and a second connector (30) for the connection of a material line (31), the connector unit being configured as a swivel joint (25) in such a manner that the first connector and the second connector are rotatable around a shared rotation axis (32) relative to the spray gun.

2. The connector unit according to claim 1, wherein the connector unit (23) is configured for being arranged on a handle (12) of the spray gun (10).

3. The connector unit according to claim 1, wherein the connector unit (23) comprises a fixed part (26) fixed relative to the spray gun 10 and a swivel part (27) rotatably connected to the fixed part, the swivel part having the first connector (28) and the second connector (30).

4. The connector unit according to claim 3, wherein the compressed air and the material are separately guidable from the swivel part (27) to the spray gun (10) via the fixed part (26).

5. The connector unit according to claim 3, wherein the swivel part (27) comprises a first connector element (37), which comprises the first connector (28), and a second connector element (40), which comprises the second connector (30), said second connector element (40) being rigidly connected to the first connector element.

6. The connector unit according to claim 3, wherein the fixed part (26) comprises a socket element (41) rigidly connectable to the spray gun (10) and an axis element (42) rigidly connected to the socket element, the swivel part (27) being rotatably mounted on said axis element (42).

7. The connector unit according to claim 6, wherein the axis element (42) has a material channel (43).

8. The connector unit according to claim 3, wherein the connector unit (23) comprises a bearing arrangement (33) having at least one bearing via which the swivel part (27) is rotatably connected to the fixed part (26).

9. The connector unit according to claim 8, wherein the bearing arrangement (33) comprises at least one axial bearing.

10. The connector unit according to claim 9, wherein the at least one axial bearing comprises an axial rolling bearing (34).

11. The connector unit according to claim 3, wherein the fixed part (26) has an air channel (60), the swivel part (27) having a ring channel (61) for the compressed air, said ring channel (61) opening into the air channel in such a manner that the compressed air is guidable from the ring channel to the air channel irrespective of a rotation angle formed between the fixed part and the swivel part.

12. The connector unit according to claim 10, wherein the connector unit (23) is disposed such on the spray gun (10) that the air channel (60) of the fixed part (26) opens into an air channel (21) of a handle (12) of the spray gun.

13. The connector unit according to claim 10, wherein the swivel part (27) has an air channel (64) running from the first connector (28) to the ring channel (61).

14. The connector unit according to claim 13, wherein the air channel (64) extends at an angle relative to the rotation axis (32).

15. The connector unit according to claim 3, wherein the fixed part (26) comprises a material outlet (58) which is connectable to a material inlet (19) of the spray gun via a material line (59), said material inlet (19) being disposed on a shaft (13) of the spray gun (10).

16. The connector unit according to claim 3, wherein the material is guidable parallel to the rotation axis (32) from the swivel part (27) into the fixed part (26) by means of the connector unit (23).

17. The connector unit according to claim 1, wherein the connector unit (23) comprises a fastening element (24) for fastening the connector unit to the spray gun (10).

18. A spray gun (10) for spraying a material using compressed air, said spray gun (10) comprising a connector unit (23) according to claim 1.

19. A method for operating a spray gun (10) configured for spraying a flowable material using compressed air, an air line (29) being connected to a first connector (28) of a connector unit (23) of the spray gun and a material line (31) being connected to a second connector (30) of the connector unit, comprising providing the first connector and the second connector for rotating relative to the spray gun around a shared rotation axis (32), by means of the connector unit configured as a swivel joint (25).

20. A method, comprising providing a connector unit (23) for a spray gun (10) configured for spraying a flowable material using compressed air, the connector unit having a first connector (28) for the connection of an air line (29) and a second connector (30) for the connection of a material line (31), the connector unit being configured as a swivel joint (25) in such a manner that the first connector and the second connector are rotatable around a shared rotation axis (32) relative to the spray gun.
